(19) United States
(12) Patent Application Publication
(10) Pub. No.: US 2022/0298407 A1
(43) Pub. Date: Sep. 22, 2022

(54) DEPOSIT-INHIBITING COMPOSITIONS FOR USE IN CRUDE OIL PRODUCTION AND PROCESSING

(71) Applicant: ChampionX USA Inc., Sugar Land, TX (US)

(72) Inventors: Christopher Alexander Russell, Sugar Land, TX (US); Emily Teresa Pohl, Pearland, TX (US); Rebecca Michele Lucente-Schultz, Missouri City, TX (US); Andrew Robert Neilson, Richmond, TX (US); Saugata Gon, Rosenberg, TX (US); Pritesh Shivshankar Sharma, Missouri City, TX (US); Tran-Bich Thi Cao, Pearland, TX (US); Andrea Brenda Gutierrez, Pearland, TX (US)

(21) Appl. No.: 17/639,077

(22) PCT Filed: Aug. 28, 2020
(86) PCT No.: PCT/US2020/048453

§ 371 Date: Feb. 28, 2022

Related U.S. Application Data
(60) Provisional application No. 62/894,004, filed on Aug. 30, 2019.

(51) Int. Cl. C09K 8/524; C09K 8/528

(52) U.S. Cl. CPC C09K 8/524; C09K 8/528

(57) ABSTRACT

A deposit-inhibiting composition has been developed that provides an advantageous reduction in the deposits of solids in the near wellbore region, and in equipment and lines used for crude oil production and processing. The deposit-inhibiting compositions contain a surface-active component comprising a phosphate ester component, a sulfurized olefin component, or a combination thereof; a polyalkylene ester; and an imidazoline compound. The deposit-inhibiting compositions are particularly useful as flow agents for delivery to a subsea wellhead via an umbilical line.

### FIELD OF THE INVENTION

A deposit-inhibiting composition has been developed that provides an advantageous reduction in the deposits of solids in equipment and lines used for crude oil production and processing. The deposit-inhibiting compositions contain a surface-active component comprising a phosphate ester component, a sulfurized olefin component, or a combination thereof; a polyalkylene ester; and an imidazoline compound. The deposit-inhibiting compositions are particularly useful as flow agents for delivery to a subsea flowline via an umbilical line.

### BACKGROUND OF THE INVENTION

In the subsea production of oil and gas, production piping typically presents a significant bottleneck because of the difficulty and expense associated with the subsea installation of the piping. The production decrease caused by bottle-necking in tubing and subsea flowlines, and in the near well-bore region of the reservoir, can have severe economic ramifications due to the resulting inability to run the hydrocarbon production system at full capacity. Preventing or reducing bottlenecking in the near wellbore region, tubing and subsea flowlines can be affected by increasing the diameter of the pipework, increasing the number of flowlines, or reducing the amount of deposition in tubing and flowlines to allow more flow through the same diameter lines. Because of the expense of increasing the size or number of production lines, it is advantageous to reduce deposition in subsea lines.

It is commonly known that a variety of flow agents are available for reducing deposition in a crude oil being transported through a conduit. Many flow agents are known for improving flow of crude oil in production and processing.

Many offshore oil and gas production facilities are operated from remote locations that can be miles away from the production wells. When remote facilities are used to operate a subsea production facility, an umbilical line can be used to provide power and various flow assurance chemicals to the production facility. These umbilical lines can have many relatively small diameter injection lines where various chemicals can be injected downhole in the production wells. These chemicals generally include low viscosity fluids such as hydrate inhibitors, wax inhibitors, scale inhibitors, asphaltene inhibitors, and corrosion inhibitors that can help to improve flow conditions during production from the reservoir to platform.

With the constraints of a relatively low viscosity (e.g., less than 500 centipoise) and high stability, a need still exists for effective flow agents that do not block or plug umbilical lines in the subsea production system.

### BRIEF SUMMARY OF THE INVENTION

This disclosure is directed to a deposition-inhibiting composition comprising a surface-active component comprising a phosphate ester component, a sulfurized olefin component, or a combination thereof; a polyalkylene ester; and an imidazoline compound.

The deposition-inhibiting compositions described herein can further comprise a solvent. The solvent can be an organic solvent, particularly, an aromatic solvent.

Additionally, the deposition-inhibiting compositions can have the surface-active component be the phosphate ester component.

Further, the surface-active component in the deposition-inhibiting compositions can be a combination of the phosphate ester component and the sulfurized olefin component.

The phosphate ester component can comprise a monobasic phosphate ester, a dibasic phosphate ester, or a combination thereof. Preferably, the phosphate ester component can comprise a mixture of a mono(alkyl) phosphate ester and a di(alkyl) phosphate ester; more preferably, the mono(alkyl) phosphate ester can comprise a mono(C₁-C₁₂ alkyl) phosphate ester and the di(alkyl) phosphate ester can comprise a di(C₁-C₁₂ alkyl) phosphate ester.

For the deposition-inhibiting compositions described herein, the mono(alkyl) phosphate ester can comprise a mono(C₆-C₁₀ alkyl) phosphate ester and the di(alkyl) phosphate ester can comprise a di(C₆-C₁₀ alkyl) phosphate ester and preferably, the mono(alkyl) phosphate ester can comprise a mono(octyl) phosphate ester and the di(alkyl) phosphate ester can comprise a di(octyl) phosphate ester. Most preferably, the mono(alkyl) phosphate ester can comprise a mono(ethylhexyl) phosphate ester and the di(alkyl) phosphate ester can comprise a di(ethylhexyl) phosphate ester.

Alternatively, the surface-active component of the deposition-inhibiting composition can be a sulfurized olefin component containing at least one double bond and a sulfur atom. Preferably, the sulfurized olefin component can comprise sulfurized 1-decene.

In the deposition-inhibiting compositions described herein, the polyalkylene ester can comprise a polyalkylene succinic ester, a polyalkylene succinic anhydride, polyalkylene succinic acid, or a combination thereof. Preferably, the polyalkylene ester can comprise a polyethylene succinic ester, a polyethylene succinic anhydride, a polypropylene succinic ester, a polypropylene succinic anhydride, a polyisobutylene succinic ester, a polyisobutylene succinic anhydride, polyalkylene succinic acid, or a combination thereof. More preferably, the polyalkylene ester can comprise a polyisobutylene succinic ester.

In particular, the polyisobutylene succinic ester can be derived from a reaction of polyisobutylene succinic anhydride and a polyol.

The polyol used to prepare the polyisobutylene succinic ester can comprise pentaerythritol, triethanolamine, glycerol, glucose, sucrose, arabitol, erythritol, maltitol, mannitol, ribitol, sorbitol, xylitol, threitol, galactitol, isomalt, iditol, lactitol, or a combination thereof; preferably, the polyol can comprise pentaerythritol.

For the deposition-inhibiting compositions described herein, the imidazoline compound has formula (I),

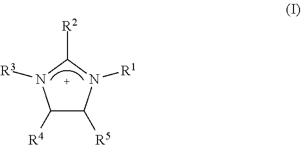

wherein R¹, R⁴, and R⁵ are each independently selected from hydrogen, alkyl, alkenyl, alkynyl, cycloalkyl, cycloalkenyl, aryl, heteroaryl, and heterocycle, said alkyl, alkenyl, alkynyl, cycloalkyl, cycloalkenyl, aryl, heteroaryl, and heterocycle each independently, at each occurrence, unsubstituted or substituted with 1 to 3 substituents independently selected from halogen, —COR⁶, —CO₂R⁷, —SO₃R⁸, —PO₃H₂, —CON(R⁹)(R¹⁰), —OR¹¹, and —N(R¹²)(R¹³); R² is a radical derived from a fatty acid; R³ is selected from a radical derived from an unsaturated acid; R⁶, R⁷, R⁸, R⁹, R¹⁰, and R¹¹ are each independently, at each occurrence, selected from hydrogen, alkyl, and alkenyl; R¹² and R¹³ are each independently, at each occurrence, selected from hydrogen, alkyl, —COR¹⁴, —CO₂R¹⁵, -alkyl-COR¹⁶, and -alkyl-CO₂R¹⁷; and R¹⁴, R¹⁵, —R¹⁶, and R¹⁷ are each independently, at each occurrence, selected from hydrogen, alkyl, and alkenyl.

The imidazoline compound can have R¹ be selected from alkyl, alkenyl, and aryl, each independently substituted with 1 to 3 substituents independently selected from —CO₂R⁷, —CON(R⁹)(R¹⁰), and —N(R¹²)(R¹³); R⁴ and R⁵ are each independently selected from hydrogen, alkyl, alkenyl, and aryl; R² is a radical derived from a C₁₀ to C₂₄ fatty acid; R³ is selected from a radical derived from a C₂ to C₆ unsaturated acid; R⁷, R⁹, and R¹⁰ are each independently, at each occurrence, selected from hydrogen, alkyl, and alkenyl; R¹² and R¹³ are each independently, at each occurrence, selected from hydrogen, alkyl, —COR¹⁴, and -alkyl-COR¹⁶; and R¹⁴ and R¹⁶ are each independently, at each occurrence, selected from hydrogen, alkyl, and alkenyl.

A preferred imidazoline compound of Formula (I) can be used wherein R¹ is unsubstituted C₂-C₆-alkyl; R² is —C₁₇H₃₅, —C₁₇H₃₃, or —C₁₇H₃₁; R³ is —CH₂CH₂CO₂R^{e}, wherein R^{e} is hydrogen, C₁-C₆-alkyl, or R^{e} is absent; R⁴ is hydrogen; and R⁵ is hydrogen.

Another preferred imidazoline compound of Formula (I) can be used wherein R¹ is linear C₂-alkyl, substituted with one substituent that is a terminal —N(R¹²)(R¹³), wherein R¹² is hydrogen and R¹³ is —COR¹⁴, wherein R¹⁴ is —C₁₇H₃₅, —C₁₇H₃₃, or —C₁₇H₃₁; R² is —C₁₇H₃₅, —C₁₇H₃₃, or —C₁₇H₃₁; R³ is —CH₂CH₂CO₂R^{e}, wherein R^{e} is hydrogen, C₁-C₆-alkyl, or R^{e} is absent; R⁴ is hydrogen; and R⁵ is hydrogen.

Yet another preferred imidazoline compound of Formula (I) can be used wherein R¹ is linear C₂-alkyl, substituted with one substituent that is a terminal —N(R¹²)(R¹³), wherein R¹² and R¹³ are each a —C₂-alkyl-CO₂R¹⁷, wherein R¹⁷ is hydrogen or R¹⁷ is absent; R² is —C₁₇H₃₅, —C₁₇H₃₃, or —C₁₇H₃₁; R³ is —CH₂CH₂CO₂R^{e}, wherein R^{e} is hydrogen, C₁-C₆-alkyl, or R^{e} is absent; R⁴ is hydrogen; and R⁵ is hydrogen.

The deposition-inhibiting compositions described herein can have the imidazoline compound be present at a concentration from about 2 wt. % to about 15 wt. %, the polyalkylene ester be present at a concentration from about 5 wt. % to about 20 wt. %, and the surface-active component be present at a concentration from about 2 wt. % to about 15 wt. %, based on the total weight of the deposition-inhibiting composition. Further, the deposition-inhibiting compositions can have the imidazoline compound be present at a concentration from about 2 wt. % to about 15 wt. %, the polyalkylene ester be present at a concentration from about 5 wt. % to about 20 wt. %, and the surface-active component be present at a concentration from about 2 wt. % to about 15 wt. %, and the solvent be present at a concentration from about 50 wt. % to about 91 wt. % based on the total weight of the deposition-inhibiting composition.

Preferably, the deposition-inhibiting compositions can have the imidazoline compound be present at a concentration from about 3 wt. % to about 7 wt. %, the polyalkylene ester be present at a concentration from about 8 wt. % to about 12 wt. %, and the surface-active component be present at a concentration from about 4 wt. % to about 8 wt. %, and the solvent be present at a concentration from about 73 wt. % to about 85 wt. % based on the total weight of the deposition-inhibiting composition.

A method for reducing or preventing deposition of a component of a crude oil is also disclosed, the method comprises contacting the crude oil with the deposition-inhibiting composition described herein.

In the methods for reducing or preventing deposition of a component of a crude oil, the component of the crude oil can be an asphaltene, a paraffin, a wax, a scale, a naphthenate, coke, or a combination thereof.

In the disclosed methods, the deposition-inhibiting composition can be contacted with the crude oil in an effective amount to disperse asphaltene.

Further, in the methods, the deposition-inhibiting composition can be contacted with the crude oil in an effective amount to disperse wax.

Also, in the disclosed methods, the deposition-inhibiting composition can be contacted with the crude oil in an effective amount to disperse the paraffin.

The disclosed methods can include contacting the deposition-inhibiting composition with the crude oil in an effective amount to disperse the naphthenate.

Additionally, in the disclosed methods, the deposition-inhibiting composition can be contacted with the crude oil in an effective amount to prevent or reduce deposition of a foulant.

In the methods for reducing or preventing deposition of a component of a crude oil, the effective amount of the deposition-inhibiting composition is from about 1 ppm to about 10,000 ppm, or from about 1 ppm to about 5,000 ppm of the deposition-inhibiting composition based on the total amount of process fluid.

The deposition-inhibiting compositions described herein can be transported through a fluid conduit having a length of at least about 500 feet wherein the viscosity of the deposition-inhibiting composition is less than 500 centipoise in the fluid conduit, at a temperature of at least 40° F. Preferably, the viscosity of the deposition-inhibiting composition in the crude oil is less than 100 centipoise in the fluid conduit.

The methods described herein can result in deposition being reduced in an umbilical line connected to a subsea wellhead for downhole injection and a flowline by contacting the deposition-inhibiting composition with the crude oil at an injection point.

Other objects and features will be in part apparent and in part pointed out hereinafter.

### BRIEF DESCRIPTION OF THE SEVERAL VIEWS OF THE DRAWING

FIG. 1 shows a graph of showing the Instability Rating and the Product Stability Index on each y-axis with the identity of the agent, xylene, Product A or Product B on the x-axis.

Corresponding reference characters indicate corresponding parts throughout the drawings.

### DETAILED DESCRIPTION OF THE INVENTION

Deposition-inhibiting compositions are disclosed that can be used in methods of delivering the product to various crude oils recovered from a hydrocarbon-containing subterranean formation. The deposition-inhibiting compositions are stable upon transport and storage and in the umbilical line. Stated another way, the deposition-inhibiting compositions described herein contain stable compositions that have advantageous properties such that none of the components of the deposition-inhibiting compositions develop a disadvantageous viscosity or precipitate to plug the umbilical line. After being contacted with the crude oil extracted from the hydrocarbon-containing subterranean reservoir, the deposition-inhibiting compositions reduce or prevent deposition of components of the crude oil to aid the flow of the crude oil in production and further processing.

The deposition-inhibiting compositions described herein have antifouling properties. These antifouling properties include prevention and/or reduction of deposition of asphaltenes, naphthenates, paraffins, waxes, and coke. The prevention or reduction of deposition aids in the production or processing of crude oils in that it allows the crude oil to flow in the system without added deposition to plug or otherwise obstruct processing lines or equipment.

Further, the deposition-inhibiting compositions also have anticorrosion properties. Without being bound by theory, it is believed that the deposition-inhibiting compositions described herein are able to place a coating on the surface of production and processing equipment it contacts and thus, can reduce corrosion on those coated surfaces.

Another advantageous property of the deposition-inhibiting compositions is the low viscosity of the deposition-inhibiting compositions under pressure. For example, when a deposition-inhibiting composition described herein is injected into a crude oil production system, the pressure created from its injection is at least 100, 500, or 1000 times less than the pressure created from a comparable commercially available product. The deposition-inhibiting compositions can be used in a lower active concentration, and in some cases, at a lower dose rate than a comparable commercially available product.

This disclosure is directed to a deposition-inhibiting composition comprising a surface-active component comprising a phosphate ester component, a sulfurized olefin component, or a combination thereof; a polyalkylene ester; and an imidazoline compound.

The deposition-inhibiting compositions described herein can further comprise a solvent. The solvent can be an organic solvent, particularly, an aromatic solvent. More preferably, the aromatic solvent comprises xylene.

Additionally, the deposition-inhibiting compositions can have the surface-active component be the phosphate ester component.

Further, the surface-active component in the deposition-inhibiting compositions can be a combination of the phosphate ester component and the sulfurized olefin component.

The phosphate ester component can comprise a monobasic phosphate ester, a dibasic phosphate ester, or a combination thereof. Preferably, the phosphate ester component can comprise a mixture of a mono(alkyl) phosphate ester and a di(alkyl) phosphate ester; more preferably, the mono(alkyl) phosphate ester can comprise a mono(C₁-C₁₂ alkyl) phosphate ester and the di(alkyl) phosphate ester can comprise a di(C₁-C₁₂ alkyl) phosphate ester.

For the deposition-inhibiting compositions described herein, the mono(alkyl) phosphate ester can comprise a mono(C₆-C₁₀ alkyl) phosphate ester and the di(alkyl) phosphate ester can comprise a di(C₆-C₁₀ alkyl) phosphate ester and preferably, the mono(alkyl) phosphate ester can comprise a mono(octyl) phosphate ester and the di(alkyl) phosphate ester can comprise a di(octyl) phosphate ester. Most preferably, the mono(alkyl) phosphate ester can comprise a mono(ethylhexyl) phosphate ester and the di(alkyl) phosphate ester can comprise a di(ethylhexyl) phosphate ester.

An exemplary mixture of a mono(alkyl) phosphate ester and a di(alkyl) phosphate ester is available from KAO Corporation, Tokyo, Japan, as Fosfodet 2-EH.

Alternatively, the surface-active component of the deposition-inhibiting composition can be a sulfurized olefin component containing at least one double bond and a sulfur atom. Preferably, the sulfurized olefin component can comprise sulfurized 1-decene.

An exemplary 1-Decene, sulfurized is commercially available from Dover Chemical, Dover, Ohio, as Mayco Base 1540 (CAS No. 72162-15-3).

In the deposition-inhibiting compositions described herein, the polyalkylene ester can comprise a polyalkylene succinic ester, a polyalkylene succinic anhydride, polyalkylene succinic acid, or a combination thereof. Preferably, the polyalkylene ester can comprise a polyethylene succinic ester, a polyethylene succinic anhydride, a polypropylene succinic ester, a polypropylene succinic anhydride, a polyisobutylene succinic ester, a polyisobutylene succinic anhydride, polyalkylene succinic acid, or a combination thereof. More preferably, the polyalkylene ester can comprise a polyisobutylene succinic ester.

In particular, the polyisobutylene succinic ester can be derived from a reaction of polyisobutylene succinic anhydride and a polyol.

The polyol used to prepare the polyisobutylene succinic ester can comprise pentaerythritol, triethanolamine, glycerol, glucose, sucrose, arabitol, erythritol, maltitol, mannitol, ribitol, sorbitol, xylitol, threitol, galactitol, isomalt, iditol, lactitol, or a combination thereof; preferably, the polyol can comprise pentaerythritol.

An exemplary polyalkylene ester is commercially available from Lubrizol Corporation, Wickliffe, Ohio, as LUBRIZOL 5948.

For the deposition-inhibiting compositions described herein, the imidazoline compound has formula (I),

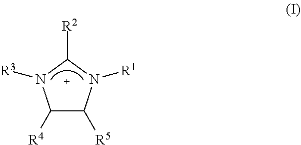

wherein R¹, R⁴, and R⁵ are each independently selected from hydrogen, alkyl, alkenyl, alkynyl, cycloalkyl, cycloalkenyl, aryl, heteroaryl, and heterocycle, said alkyl, alkenyl, alkynyl, cycloalkyl, cycloalkenyl, aryl, heteroaryl, and heterocycle each independently, at each occurrence, unsubstituted or substituted with 1 to 3 substituents independently selected from halogen, —COR⁶, —CO₂R⁷, —SO₃R⁸, —PO₃H₂, —CON(R⁹)(R¹⁰), —OR¹¹, and —N(R¹²)(R¹³); R² is a radical derived from a fatty acid; R³ is selected from a radical derived from an unsaturated acid; R⁶, R⁷, R⁸, R⁹, R¹⁰, and R¹¹ are each independently, at each occurrence, selected from hydrogen, alkyl, and alkenyl; R¹² and R¹³ are each independently, at each occurrence, selected from hydrogen, alkyl, —COR¹⁴, —CO₂R¹⁵, -alkyl-COR¹⁶, and -alkyl-CO₂R¹⁷; and R¹⁴, R¹⁵, —R¹⁶, and R¹⁷ are each independently, at each occurrence, selected from hydrogen, alkyl, and alkenyl.

The imidazoline compound can have R¹ be selected from alkyl, alkenyl, and aryl, each independently substituted with 1 to 3 substituents independently selected from —CO₂R⁷, —CON(R⁹)(R¹⁰), and —N(R¹²)(R¹³); R⁴ and R⁵ are each independently selected from hydrogen, alkyl, alkenyl, and aryl; R² is a radical derived from a C₁₀ to C₂₄ fatty acid; R³ is selected from a radical derived from a C₂ to C₆ unsaturated acid; R⁷, R⁹, and R¹⁰ are each independently, at each occurrence, selected from hydrogen, alkyl, and alkenyl; R¹² and R¹³ are each independently, at each occurrence, selected from hydrogen, alkyl, —COR¹⁴, and -alkyl-COR¹⁶; and R¹⁴ and R¹⁶ are each independently, at each occurrence, selected from hydrogen, alkyl, and alkenyl.

A preferred imidazoline compound of Formula (I) can be used wherein R¹ is unsubstituted C₂-C₆-alkyl; R² is —C₁₇H₃₅, —C₁₇H₃₃, or —C₁₇H₃₁; R³ is —CH₂CH₂CO₂R^{e}, wherein R^{e} is hydrogen, C₁-C₆-alkyl, or R^{e} is absent; R⁴ is hydrogen; and R⁵ is hydrogen.

Another preferred imidazoline compound of Formula (I) can be used wherein R¹ is linear C₂-alkyl, substituted with one substituent that is a terminal —N(R¹²)(R¹³), wherein R¹² is hydrogen and R¹³ is —COR¹⁴, wherein R¹⁴ is —C₁₇H₃₅, —C₁₇H₃₃, or —C₁₇H₃₁; R² is —C₁₇H₃₅, —C₁₇H₃₃, or —C₁₇H₃₁; R³ is —CH₂CH₂CO₂R^{e}, wherein R^{e} is hydrogen, C₁-C₆-alkyl, or R^{e} is absent; R⁴ is hydrogen; and R⁵ is hydrogen.

Yet another preferred imidazoline compound of Formula (I) can be used wherein R¹ is linear C₂-alkyl, substituted with one substituent that is a terminal —N(R¹²)(R¹³), wherein R¹² and R¹³ are each a —C₂-alkyl-CO₂R¹⁷, wherein R¹⁷ is hydrogen or R¹⁷ is absent; R² is —C₁₇H₃₅, —C₁₇H₃₃, or —C₁₇H₃₁; R³ is —CH₂CH₂CO₂R^{e}, wherein R^{e} is hydrogen, C₁-C₆-alkyl, or R^{e} is absent; R⁴ is hydrogen; and R⁵ is hydrogen.

Methods for preparing the imidazoline compounds of Formula (I) can be found in U.S. Pat. No. 7,057,050.

The deposition-inhibiting compositions described herein can have the imidazoline compound be present at a concentration from about 2 wt. % to about 15 wt. %, the polyalkylene ester be present at a concentration from about 5 wt. % to about 20 wt. %, and the surface-active component be present at a concentration from about 2 wt. % to about 15 wt. %, based on the total weight of the deposition-inhibiting composition. Further, the deposition-inhibiting compositions can have the imidazoline compound be present at a concentration from about 2 wt. % to about 15 wt. %, the polyalkylene ester be present at a concentration from about 5 wt. % to about 20 wt. %, and the surface-active component be present at a concentration from about 2 wt. % to about 15 wt. %, and the solvent be present at a concentration from about 50 wt. % to about 91 wt. % based on the total weight of the deposition-inhibiting composition.

Preferably, the deposition-inhibiting compositions can have the imidazoline compound be present at a concentration from about 3 wt. % to about 7 wt. %, the polyalkylene ester be present at a concentration from about 8 wt. % to about 12 wt. %, and the surface-active component be present at a concentration from about 4 wt. % to about 8 wt. %, and the solvent be present at a concentration from about 73 wt. % to about 85 wt. % based on the total weight of the deposition-inhibiting composition.

The deposition-inhibiting composition can further consist essentially of a surface-active component, a polyalkylene ester, and an imidazoline compound as described herein. The deposition-inhibiting composition consisting essentially of these components has the novel properties of acceptable reduction or prevention of deposition of the disclosed components of crude oil and an acceptable stability of the deposition-inhibiting composition so that components of the composition will not separate or precipitate when used in the methods described herein, particularly in a subsea production process.

The deposition-inhibiting composition can further consist of a surface-active component, a polyalkylene ester, and an imidazoline compound as described herein.

A method for reducing or preventing deposition of a component of a crude oil is also disclosed, the method comprises contacting the crude oil with the deposition-inhibiting composition described herein.

In the methods for reducing or preventing deposition of a component of a crude oil, the component of the crude oil can be an asphaltene, a paraffin, a wax, a scale, a naphthenate, coke, or a combination thereof.

In the disclosed methods, the deposition-inhibiting composition can be contacted with the crude oil in an effective amount to disperse asphaltene.

Further, in the methods, the deposition-inhibiting composition can be contacted with the crude oil in an effective amount to disperse wax.

Also, in the disclosed methods, the deposition-inhibiting composition can be contacted with the crude oil in an effective amount to disperse the paraffin.

The disclosed methods can include contacting the deposition-inhibiting composition with the crude oil in an effective amount to disperse the naphthenate.

Additionally, in the disclosed methods, the deposition-inhibiting composition can be contacted with the crude oil in an effective amount to prevent or reduce deposition of a foulant.

In the methods for reducing or preventing deposition of a component of a crude oil, the effective amount of the deposition-inhibiting composition is from about 1 ppm to about 10,000 ppm, from about 1 ppm to about 9,500 ppm, from about 1 ppm to about 9,000 ppm, from about 1 ppm to about 8,500 ppm, from about 1 ppm to about 8,000 ppm, from about 1 ppm to about 7,500 ppm, from about 1 ppm to about 7,000 ppm, from about 1 ppm to about 6,500 ppm, from about 1 ppm to about 6,000 ppm, from about 1 ppm to about 5,500 ppm, or from about 1 ppm to about 5,000 ppm of the deposition-inhibiting composition based on the total amount of process fluid.

The deposition-inhibiting compositions described herein can be transported through a fluid conduit having a length of at least about 500 feet wherein the viscosity of the deposition-inhibiting composition is less than 500 centipoise in the fluid conduit at a temperature of at least 40° F. Preferably, the viscosity of the deposition-inhibiting composition in the crude oil is less than 100 centipoise in the fluid conduit.

The methods described herein can result in deposition being reduced in subsea tubing and flowlines via application by an umbilical line connected to a subsea production facility by contacting the deposition-inhibiting composition with the crude oil at an injection point.

The deposition-inhibiting compositions can be injected into an umbilical line that is part of an offshore production system. The offshore production system can include a plurality of subsea wellheads, a common production manifold, an offshore platform, a subsea flowline, and an umbilical line. Each wellhead can operate to produce a hydrocarbon-containing fluid (e.g., crude oil) from a subterranean hydrocarbon-containing formation. Each wellhead is also connected to the production manifold so that the produced hydrocarbon-containing fluid can flow and be combined with the produced hydrocarbons from other wellheads. The combined produced hydrocarbons can flow from the production manifold to the offshore platform through the subsea flowline. The umbilical line can be connected to a control device on the offshore platform and to either the wellheads, the production manifold, or the subsea flowline.

The length of the umbilical line is typically at least about 500 feet, more typically, at least about 1000 feet, or more.

The deposition-inhibiting compositions have physical properties that allow pumping through an umbilical line long distances at typical operating conditions of from 40° C. to 2° C. and a pressure from atmospheric pressure to 15,000 pounds per square inch (psi).

Further, in the methods, the deposition-inhibiting composition can comprise an effective amount of the components of the deposition-inhibiting composition and an additional component selected from the group consisting of a corrosion inhibitor, an organic solvent, an asphaltene inhibitor, a paraffin inhibitor, a scale inhibitor, an emulsifier, a water clarifier, a dispersant, an emulsion breaker, a reverse emulsion breaker, a gas hydrate inhibitor, a biocide, a pH modifier, a surfactant, and a combination thereof.

The deposition-inhibiting composition can comprise from about 10 to about 90 wt. % of the deposition-inhibiting composition components and from about 10 to about 80 wt. % of the additional component, preferably from about 50 to about 90 wt. % of deposition-inhibiting composition components and from about 10 to about 50 wt. % of the additional component, and more preferably from about 65 to about 85 wt. % of deposition-inhibiting composition components and from about 15 to about 35 wt. % of the additional component.

The additional component of the deposition-inhibiting composition can comprise water or an organic solvent. The composition can comprise from about 1 to 80 wt. %, from about 5 to 50 wt. %, or from about 10 to 35 wt. % of the water or the one or more organic solvents, based on total weight of the composition. The organic solvent can comprise an alcohol, a hydrocarbon, a ketone, an ether, an alkylene glycol, a glycol ether, an amide, a nitrile, a sulfoxide, an ester, or a combination thereof. Examples of suitable organic solvents include, but are not limited to, methanol, ethanol, propanol, isopropanol, butanol, 2-ethylhexanol, hexanol, octanol, decanol, 2-butoxyethanol, methylene glycol, ethylene glycol, 1,2-propylene glycol, 1,3-propylene glycol, diethyleneglycol monomethyl ether, diethylene glycol monoethyl ether, ethylene glycol monobutyl ether, ethylene glycol dibutyl ether, pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof.

The additional component of the deposition-inhibiting composition can comprise a corrosion inhibitor. The composition can comprise from about 0.1 to 20 wt. %, 0.1 to 10 wt. %, or 0.1 to 5 wt. % of the corrosion inhibitors, based on total weight of the composition. A composition can comprise from 0.1 to 10 percent by weight of the corrosion inhibitors, based on total weight of the composition. The composition can comprise 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, 9.5 wt %, 10.0 wt %, 10.5 wt %, 11.0 wt %, 11.5 wt %, 12.0 wt %, 12.5 wt %, 13.0 wt %, 13.5 wt %, 14.0 wt %, 14.5 wt %, or 15.0 wt % by weight of the corrosion inhibitors, based on total weight of the composition. Each system can have its own requirements, and the weight percent of one or more additional corrosion inhibitors in the composition can vary with the system in which it is used.

The corrosion inhibitor can comprise an imidazoline compound, a quaternary ammonium compound, a pyridinium compound, or a combination thereof.

The corrosion inhibitor component can comprise an imidazoline. The imidazoline can be, for example, imidazoline derived from a diamine, such as ethylene diamine (EDA), diethylene triamine (DETA), triethylene tetraamine (TETA) etc. and a long chain fatty acid such as tall oil fatty acid (TOFA). The imidazoline can be an imidazoline of Formula (I) or an imidazoline derivative. Representative imidazoline derivatives include an imidazolinium compound of Formula (II) or a bis-quaternized compound of Formula (III).

The corrosion inhibitor component can include an imidazoline of Formula (I):

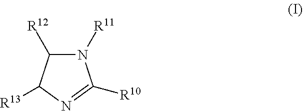

wherein R¹⁰ is a C₁-C₂₀ alkyl or a C₁-C₂₀ alkoxyalkyl group; R¹¹ is hydrogen, C₁-C₆ alkyl, C₁-C₆ hydroxyalkyl, or C₁-C₆ arylalkyl; and R¹² and R¹³ are independently hydrogen or a C₁-C₆ alkyl group. Preferably, the imidazoline includes an R¹⁰ which is the alkyl mixture typical in tall oil fatty acid (TOFA), and R¹¹, R¹² and R¹³ are each hydrogen.

The corrosion inhibitor component can include an imidazolinium compound of Formula (II):

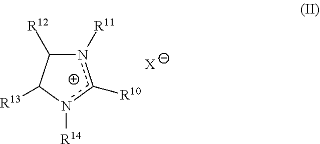

wherein R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl; R¹² and R¹³ are independently hydrogen or a C₁-C₆ alkyl group; and X⁻ is a halide (such as chloride, bromide, or iodide), carbonate, sulfonate, phosphate, or the anion of an organic carboxylic acid (such as acetate). Preferably, the imidazolinium compound includes 1-benzyl-1-(2-hydroxyethyl)-2-tall-oil-2-imidazolinium chloride.

The corrosion inhibitor can comprise a bis-quaternized compound having the formula (III):

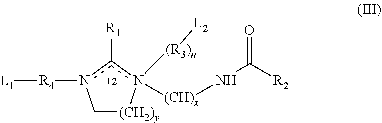

wherein R₁ and R₂ are each independently unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof; R³ and R⁴ are each independently unsubstituted branched, chain or ring alkylene or alkenylene having from 1 to about 29 carbon atoms; partially or fully oxygenized, sulfurized, and/or phosphorylized branched, chain, or ring alkylene or alkenylene having from 1 to about 29 carbon atoms; or a combination thereof; L₁ and L₂ are each independently absent, H, —COOH, —SO₃H, —PO₃H₂, —COOR₅, —CONH₂, —CONHR₅, or —CON(R⁵)₂; R⁵ is each independently a branched or unbranched alkyl, aryl, alkylaryl, alkylheteroaryl, cycloalkyl, or heteroaryl group having from 1 to about 10 carbon atoms; n is 0 or 1, and when n is 0, L₂ is absent or H; x is from 1 to about 10; and y is from 1 to about 5. Preferably, R₁ and R₂ are each independently C₆-C₂₂ alkyl, C₈-C₂₀ alkyl, C₁₂-C₁₈ alkyl, C₁₆-C₁₈ alkyl, or a combination thereof; R₃ and R₄ are alkylene, C₂-C₈ alkylene, C₂-C₆ alkylene, or C₂-C₃ alkylene; n is 0 or 1; x is 2; y is 1; R₃ and R₄ are —C₂H₂—; L₁ is —COOH, —SO₃H, or —PO₃H₂; and L₂ is absent, H, —COOH, —SO₃H, or —PO₃H₂. For example, R₁ and R₂ can be derived from a mixture of tall oil fatty acids and are predominantly a mixture of C₁₇H₃₃ and C₁₇H₃₁ or can be C₁₆-C₁₈ alkyl; R³ and R⁴ can be C₂-C₃ alkylene such as —C₂H₂—; n is 1 and L₂ is —COOH or n is 0 and L₂ is absent or H; x is 2; y is 1; R₃ and R⁴ are —C₂H₂—; and L₁ is —COOH.

It should be appreciated that the number of carbon atoms specified for each group of formula (III) refers to the main chain of carbon atoms and does not include carbon atoms that may be contributed by substituents.

The corrosion inhibitor can comprise a bis-quaternized imidazoline compound having the formula (III) wherein R₁ and R₂ are each independently C₆-C₂₂ alkyl, C₈-C₂₀ alkyl, C₁₂-C₁₈ alkyl, or C₁₆-C₁₈ alkyl or a combination thereof; R₄ is C₁-C₁₀ alkylene, C₂-C₈ alkylene, C₂-C₆ alkylene, or C₂-C₃ alkylene; x is 2; y is 1; n is 0; L₁ is —COOH, —SO₃H, or —PO₃H₂; and L₂ is absent or H. Preferably, a bis-quaternized compound has the formula (III) wherein R₁ and R₂ are each independently C₁₆-C₁₈ alkyl; R₄ is —C₂H₂—; x is 2; y is 1; n is 0; L₁ is —COOH, —SO₃H, or —PO₃H₂ and L₂ is absent or H.

The corrosion inhibitor can be a quaternary ammonium compound of Formula (IV):

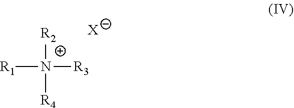

wherein R₁, R₂, and R₃ are independently C₁ to C₂₀ alkyl, R₄ is methyl or benzyl, and X⁻ is a halide or methosulfate.

Suitable alkyl, hydroxyalkyl, alkylaryl, arylalkyl or aryl amine quaternary salts include those alkylaryl, arylalkyl and aryl amine quaternary salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I. For the quaternary salts, R^{5a}, R^{6a}, R^{7a}, and R^{8a} can each be independently selected from the group consisting of alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X⁻] wherein R^{5a}, R^{6a}, R^{7a}, and R^{8a} contain one to 18 carbon atoms and at least one aryl group, and X is Cl, Br or I.

Suitable quaternary ammonium salts include, but are not limited to, a tetramethyl ammonium salt, a tetraethyl ammonium salt, a tetrapropyl ammonium salt, a tetrabutyl ammonium salt, a tetrahexyl ammonium salt, a tetraoctyl ammonium salt, a benzyltrimethyl ammonium salt, a benzyltriethyl ammonium salt, a phenyltrimethyl ammonium salt, a phenyltriethyl ammonium salt, a cetyl benzyldimethyl ammonium salt, a hexadecyl trimethyl ammonium salt, a dimethyl alkyl benzyl quaternary ammonium salt, a monomethyl dialkyl benzyl quaternary ammonium salt, or a trialkyl benzyl quaternary ammonium salt, wherein the alkyl group has about 6 to about 24 carbon atoms, about 10 and about 18 carbon atoms, or about 12 to about 16 carbon atoms. The quaternary ammonium salt can be a benzyl trialkyl quaternary ammonium salt, a benzyl triethanolamine quaternary ammonium salt, or a benzyl dimethylaminoethanolamine quaternary ammonium salt.

The corrosion inhibitor component can comprise a pyridinium salt such as those represented by Formula (V):

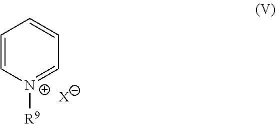

wherein R⁹ is an alkyl group, an aryl group, or an arylalkyl group, wherein said alkyl groups have from 1 to about 18 carbon atoms and X⁻ is a halide such as chloride, bromide, or iodide. Among these compounds are alkyl pyridinium salts and alkyl pyridinium benzyl quats. Exemplary compounds include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium chloride and an alkyl benzyl pyridinium chloride, preferably wherein the alkyl is a C₁-C₆ hydrocarbyl group. Preferably, the pyridinium compound includes benzyl pyridinium chloride.

The corrosion inhibitor components can also include phosphate esters, monomeric or oligomeric fatty acids, or alkoxylated amines.

The corrosion inhibitor component can comprise a phosphate ester. Suitable mono-, di- and tri-alkyl as well as alkylaryl phosphate esters and phosphate esters of mono, di, and triethanolamine typically contain between from 1 to about 18 carbon atoms. Preferred mono-, di- and trialkyl phosphate esters, alkylaryl or arylalkyl phosphate esters are those prepared by reacting a C₃-C₁₈ aliphatic alcohol with phosphorous pentoxide. The phosphate intermediate interchanges its ester groups with triethylphosphate producing a more broad distribution of alkyl phosphate esters.

Alternatively, the phosphate ester can be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

The corrosion inhibitor component can include a monomeric or oligomeric fatty acid. Preferred monomeric or oligomeric fatty acids are C₁₄-C₂₂ saturated and unsaturated fatty acids as well as dimer, trimer and oligomer products obtained by polymerizing one or more of such fatty acids.

The corrosion inhibitor component can comprise an alkoxylated amine. The alkoxylated amine can be an ethoxylated alkyl amine. The alkoxylated amine can be ethoxylated tallow amine.

The additional component of the composition can comprise an organic sulfur compound, such as a mercaptoalkyl alcohol, mercaptoacetic acid, thioglycolic acid, 3,3′-dithiodipropionic acid, sodium thiosulfate, thiourea, L-cysteine, tert-butyl mercaptan, sodium thiosulfate, ammonium thiosulfate, sodium thiocyanate, ammonium thiocyanate, sodium metabisulfite, or a combination thereof. Preferably, the mercaptoalkyl alcohol comprises 2-mercaptoethanol. The organic sulfur compound can constitute 0.5 to 15 wt. % of the composition, based on total weight of the composition, preferably about 1 to about 10 wt. % and more preferably about 1 to about 5 wt. %. The organic sulfur compound can constitute 1, 2, 3, 4, 5, 6, 7, 8, 9, 10, 11, 12, 13, 14 or 15 wt. % of the composition.

The composition can be substantially free of or free of any organic sulfur compound. A composition is substantially free of any organic sulfur compound if it contains an amount of organic sulfur compound below the amount that will produce hydrogen sulfide gas upon storage at a temperature of 25° C. and ambient pressure.

The composition can comprise a demulsifier. Preferably, the demulsifier comprises an oxyalkylate polymer, such as a polyalkylene glycol. The demulsifier can constitute from about 0.1 to 10 wt. %, from about 0.5 to 5 wt. %, or from about 0.5 to 4 wt. % of the composition, based on total weight of the composition. The demulsifier can constitute 0.5, 1, 1.5, 2, 2.5, 3, 3.5, 4, 4.5 or 5 wt. % of the composition.

The composition can include an asphaltene inhibitor. The composition can comprise from about 0.1 to 10 wt. %, from about 0.1 to 5 wt. %, or from about 0.5 to 4 wt. % of an asphaltene inhibitor, based on total weight of the composition. Suitable asphaltene inhibitors include, but are not limited to, aliphatic sulfonic acids; alkyl aryl sulfonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids, salts of alkyl succinates, sorbitan monooleate, and polyisobutylene succinic anhydride.

The composition can include a paraffin inhibitor. The composition can comprise from about 0.1 to 10 wt. %, from about 0.1 to 5 wt. %, or from about 0.5 to 4 wt. % of a paraffin inhibitor, based on total weight of the composition. Suitable paraffin inhibitors include, but are not limited to, paraffin crystal modifiers, and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes. Suitable paraffin dispersants include, but are not limited to, dodecyl benzene sulfonate, oxyalkylated alkylphenols, and oxyalkylated alkylphenolic resins.

The composition can include a scale inhibitor. The composition can comprise from about 0.1 to 20 wt. %, from about 0.5 to 10 wt. %, or from about 1 to 10 wt. % of a scale inhibitor, based on total weight of the composition. Suitable scale inhibitors include, but are not limited to, phosphates, phosphate esters, phosphoric acids, phosphonates, phosphonic acids, polyacrylamides, salts of acrylamidomethyl propane sulfonate/acrylic acid copolymer (AMPS/AA), phosphinated maleic copolymer (PHOS/MA), and salts of a polymaleic acid/acrylic acid/acrylamidomethyl propane sulfonate terpolymer (PMA/AA/AMPS).

The composition can include an emulsifier. The composition can comprise from about 0.1 to 10 wt. %, from about 0.5 to 5 wt. %, or from about 0.5 to 4 wt. % of an emulsifier, based on total weight of the composition. Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers).

The composition can include a water clarifier. The composition can comprise from about 0.1 to 10 wt. %, from about 0.5 to 5 wt. %, or from about 0.5 to 4 wt. % of a water clarifier, based on total weight of the composition. Suitable water clarifiers include, but are not limited to, inorganic metal salts such as alum, aluminum chloride, and aluminum chlorohydrate, or organic polymers such as acrylic acid based polymers, acrylamide based polymers, polymerized amines, alkanolamines, thiocarbamates, and cationic polymers such as diallyldimethylammonium chloride (DADMAC).

The composition can include a dispersant. The composition can comprise from about 0.1 to 10 wt. %, from about 0.5 to 5 wt. %, or from about 0.5 to 4 wt. % of a dispersant, based on total weight of the composition. Suitable dispersants include, but are not limited to, aliphatic phosphonic acids with 2-50 carbons, such as hydroxyethyl diphosphonic acid, and aminoalkyl phosphonic acids, e.g. polyaminomethylene phosphonates with 2-10 N atoms e.g. each bearing at least one methylene phosphonic acid group; examples of the latter are ethylenediamine tetra(methylene phosphonate), diethylenetriamine penta(methylene phosphonate), and the triamine- and tetramine-polymethylene phosphonates with 2-4 methylene groups between each N atom, at least 2 of the numbers of methylene groups in each phosphonate being different. Other suitable dispersion agents include lignin, or derivatives of lignin such as lignosulfonate and naphthalene sulfonic acid and derivatives.

The composition can include an emulsion breaker. The composition can comprise from about 0.1 to 10 wt. %, from about 0.5 to 5 wt. %, or from about 0.5 to 4 wt. % of an emulsion breaker, based on total weight of the composition. Suitable emulsion breakers include, but are not limited to, dodecylbenzylsulfonic acid (DDBSA), the sodium salt of xylenesulfonic acid (NAXSA), epoxylated and propoxylated compounds, anionic, cationic and nonionic surfactants, and resins, such as phenolic and epoxide resins.

The composition can include a hydrogen sulfide scavenger. The composition can comprise from about 1 to 50 wt. %, from about 1 to 40 wt. %, or from about 1 to 30 wt. % of a hydrogen sulfide scavenger, based on total weight of the composition. Suitable additional hydrogen sulfide scavengers include, but are not limited to, oxidants (e.g., inorganic peroxides such as sodium peroxide or chlorine dioxide); aldehydes (e.g., of 1-10 carbons such as formaldehyde, glyoxal, glutaraldehyde, acrolein, or methacrolein; triazines (e.g., monoethanolamine triazine, monomethylamine triazine, and triazines from multiple amines or mixtures thereof); condensation products of secondary or tertiary amines and aldehydes, and condensation products of alkyl alcohols and aldehydes.

The composition can include a gas hydrate inhibitor. The composition can comprise from about 0.1 to 25 wt. %, from about 0.1 to 20 wt. %, or from about 0.3 to 20 wt. % of a gas hydrate inhibitor, based on total weight of the composition. Suitable gas hydrate inhibitors include, but are not limited to, thermodynamic hydrate inhibitors (THI), kinetic hydrate inhibitors (KHI), and anti-agglomerates (AA). Suitable thermodynamic hydrate inhibitors include, but are not limited to, sodium chloride, potassium chloride, calcium chloride, magnesium chloride, sodium bromide, formate brines (e.g. potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, and sugar alcohols (e.g. sorbitol, mannitol)), methanol, propanol, ethanol, glycol ethers (such as diethyleneglycol monomethylether, ethyleneglycol monobutylether), and alkyl or cyclic esters of alcohols (such as ethyl lactate, butyl lactate, methylethyl benzoate).

The composition can include a kinetic hydrate inhibitor. The composition can comprise from about 5 to 30 wt. %, from about 5 to 25 wt. %, or from about 10 to 25 wt. % of a kinetic hydrate inhibitor, based on total weight of the composition. Suitable kinetic hydrate inhibitors and anti-agglomerates include, but are not limited to, polymers and copolymers, polysaccharides (such as hydroxyethylcellulose (HEC), carboxymethylcellulose (CMC), starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines), hydrocarbon based dispersants (such as lignosulfonates, iminodisuccinates, polyaspartates), amino acids, and proteins.

The composition can include a biocide. The composition can comprise from about 0.1 to 10 wt. %, from about 0.5 to 5 wt. %, or from about 0.5 to 4 wt. % of a biocide, based on total weight of the composition. Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis(hydroxymethyl)-phosphonium sulfate (THPS)). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

The composition can include a pH modifier. The composition can comprise from about 0.1 to 20 wt. %, from about 0.5 to 10 wt. %, or from about 0.5 to 5 wt. % of a pH modifier, based on total weight of the composition. Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. Exemplary pH modifiers include sodium hydroxide, potassium hydroxide, calcium hydroxide, calcium oxide, sodium carbonate, potassium carbonate, sodium bicarbonate, potassium bicarbonate, magnesium oxide, and magnesium hydroxide.

The composition can include a surfactant. The composition can comprise from about 0.1 to 10 wt. %, from about 0.5 to 5 wt. %, or from about 0.5 to 4 wt. % of a surfactant, based on total weight of the composition. Suitable surfactants include, but are not limited to, anionic surfactants and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and mono and dialkyl sulfosuccinates and sulfosuccinamates. Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkoyl polyethylene glycol esters and diesters. Also included are betaines and sultanes, amphoteric surfactants such as alkyl amphoacetates and amphodiacetates, alkyl amphopropionates and amphodipropionates, and alkyliminodipropionate.

Deposition-inhibiting compositions made according to the invention can further include additional functional agents or additives that provide a beneficial property. Deposition-inhibiting compositions of the invention may include any combination of the following additional agents or additives. Such additional agents or additives include sequestrants, solubilizers, lubricants, buffers, cleaning agents, rinse aids, preservatives, binders, thickeners or other viscosity modifiers, processing aids, carriers, water-conditioning agents, foam inhibitors or foam generators, threshold agents or systems, aesthetic enhancing agents (i.e., dyes, odorants, perfumes), or other additives suitable for formulation with a corrosion inhibitor composition, and mixtures thereof. Additional agents or additives will vary according to the particular deposition-inhibiting inhibitor composition being manufactured and its intended use as one skilled in the art will appreciate.

Alternatively, the compositions may be devoid of any of the additional agents or additives.

Additionally, the deposition-inhibiting composition can be formulated into a treatment fluid comprising the following components. These formulations include the ranges of the components listed and can optionally include additional agents.

| Component | 1 | 2 | 3 | 4 | 5 | 6 | 7 | 8 | 9 | 10 | 11 | 12 |
|---|---|---|---|---|---|---|---|---|---|---|---|---|
| Deposition- | 10-90 | 10-90 | 10-90 | 10-90 | 10-90 | 10-90 | 25-85 | 25-85 | 25-85 | 25-85 | 25-85 | 10-90 |
| inhibiting | | | | | | | | | | | | |
| composition | | | | | | | | | | | | |
| (wt. %) | | | | | | | | | | | | |
| Organic | 10-35 | | | | | | 10-35 | | | | | 10-35 |
| solvent | | | | | | | | | | | | |
| (wt. %) | | | | | | | | | | | | |
| Corrosion | 0.1-20 | 0.1-20 | | | | | 0.1-20 | 0.1-20 | | | | 0.1-20 |
| inhibitor | | | | | | | | | | | | |
| (wt. %) | | | | | | | | | | | | |
| Asphaltene | 0.1-5 | 0.1-5 | 0.1-5 | 0.1-5 | | | 0.1-5 | 0.1-5 | 0.1-5 | | | 0.1-5 |
| inhibitor | | | | | | | | | | | | |
| (wt. %) | | | | | | | | | | | | |
| Paraffin | | | | | | | | | | | | |
| inhibitor | | | | | | | | | | | | |
| (wt. %) | | | | | | | | | | | | |
| Scale | 1-10 | 1-10 | 1-10 | 1-10 | 1-10 | | 1-10 | 1-10 | 1-10 | 1-10 | 1-10 | 1-10 |
| inhibitor | | | | | | | | | | | | |
| (wt. %) | | | | | | | | | | | | |
| Emulsifier | | | | | | | | | | | | |
| (wt. %) | | | | | | | | | | | | |
| Water | | | | | | | | | | | | |
| clarifier | | | | | | | | | | | | |
| (wt. %) | | | | | | | | | | | | |
| Dispersant | | | | | | | | | | | | |
| (wt. %) | | | | | | | | | | | | |
| Emulsion | | | | | | | | | | | | |
| breaker | | | | | | | | | | | | |
| (wt. %) | | | | | | | | | | | | |
| Gas hydrate | | | | | | | | | | | | 0.1-25 |
| inhibitor | | | | | | | | | | | | |
| (wt. %) | | | | | | | | | | | | |
| Biocide | 0.5-5 | 0.5-5 | 0.5-5 | 0.5-5 | 0.5-5 | 0.5-5 | 0.5-5 | 0.5-5 | 0.5-5 | 0.5-5 | 0.5-5 | |
| (wt. %) | | | | | | | | | | | | |
| Component | 13 | 14 | 15 | 16 | 17 | 18 | 19 | 20 | 21 | 22 | 23 | 24 |
| Deposition- | 10-90 | 10-90 | 10-90 | 10-90 | 10-90 | 10-90 | 25-85 | 25-85 | 25-85 | 25-85 | 25-85 | 25-85 |
| inhibiting | | | | | | | | | | | | |
| composition | | | | | | | | | | | | |
| (wt. %) | | | | | | | | | | | | |
| Organic | | | | | | | | | | | | |
| solvent | | | | | | | | | | | | |
| (wt. %) | | | | | | | | | | | | |
| Corrosion | 0.1-20 | 0.1-20 | 0.1-20 | 0.1-20 | 0.1-20 | 0.1-20 | 0.1-20 | 0.1-20 | 0.1-20 | 0.1-20 | 0.1-20 | 0.1-20 |
| inhibitor | | | | | | | | | | | | |
| (wt. %) | | | | | | | | | | | | |
| Asphaltene | 0.1-5 | | | | | | 0.1-5 | | | | | |
| inhibitor | | | | | | | | | | | | |
| (wt. %) | | | | | | | | | | | | |
| Paraffin | | | | | | | | | | | | |
| inhibitor | | | | | | | | | | | | |
| (wt. %) | | | | | | | | | | | | |
| Scale | 1-10 | 1-10 | | | 1-10 | | 1-10 | 1-10 | | | | 1-10 |
| inhibitor | | | | | | | | | | | | |
| (wt. %) | | | | | | | | | | | | |
| Emulsifier | | | | | | | | | | | | |
| (wt. %) | | | | | | | | | | | | |
| Water | | | | | | | | | | | | |
| clarifier | | | | | | | | | | | | |
| (wt. %) | | | | | | | | | | | | |
| Dispersant | | | | | | | | | | | | |
| (wt. %) | | | | | | | | | | | | |
| Emulsion | | | | | | | | | | | | |
| breaker | | | | | | | | | | | | |
| (wt. %) | | | | | | | | | | | | |
| Gas hydrate | 0.1-25 | 0.1-25 | 0.1-25 | | | | 0.1-25 | 0.1-25 | 0.1-25 | | 0.1-25 | |
| inhibitor | | | | | | | | | | | | |
| (wt. %) | | | | | | | | | | | | |
| Biocide | | | | | | 0.5-5 | 0.5-5 | 0.5-5 | 0.5-5 | 0.5-5 | | |
| (wt. %) | | | | | | | | | | | | |

### Definitions

The term “suitable substituent,” as used herein, is intended to mean a chemically acceptable functional group, preferably a moiety that does not negate the activity of the inventive compounds. Such suitable substituents include, but are not limited to halo groups, perfluoroalkyl groups, perfluoroalkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)-groups, heterocylic groups, cycloalkyl groups, amino groups, alkyl—and dialkylamino groups, carbamoyl groups, alkylcarbonyl groups, alkoxycarbonyl groups, alkylaminocarbonyl groups, dialkylamino carbonyl groups, arylcarbonyl groups, aryloxycarbonyl groups, alkylsulfonyl groups, and arylsulfonyl groups. Those skilled in the art will appreciate that many substituents can be substituted by additional substituents.

The term “alkyl,” as used herein, refers to a linear or branched hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyl groups include, but are not limited to, methyl, ethyl, n-propyl, isopropyl, n-butyl, iso-butyl, secondary-butyl, and tertiary-butyl. Alkyl groups may be unsubstituted or substituted by one or more suitable substituents, as defined above.

The term “alkenyl,” as used herein, refers to a straight or branched hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, and having one or more carbon-carbon double bonds. Alkenyl groups include, but are not limited to, ethenyl, 1-propenyl, 2-propenyl (allyl), iso-propenyl, 2-methyl-1-propenyl, 1-butenyl, and 2-butenyl. Alkenyl groups may be unsubstituted or substituted by one or more suitable substituents, as defined above.

The term “alkynyl,” as used herein, refers to a straight or branched hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, and having one or more carbon-carbon triple bonds. Alkynyl groups include, but are not limited to, ethynyl, propynyl, and butynyl. Alkynyl groups may be unsubstituted or substituted by one or more suitable substituents, as defined above.

The term “alkoxy,” as used herein, refers to an alkyl group, as defined herein, appended to the parent molecular moiety through an oxygen atom.

The term “aryl,” as used herein, means monocyclic, bicyclic, or tricyclic aromatic radicals such as phenyl, naphthyl, tetrahydronaphthyl, indanyl and the like; optionally substituted by one or more suitable substituents, preferably 1 to 5 suitable substituents, as defined above.

The term “arylalkyl,” as used herein, refers to an aryl group attached to the parent molecular moiety through an alkyl group. Arylalkyl groups may be unsubstituted or substituted by one or more suitable substituents, as defined above.

The term “cycloalkyl,” as used herein, refers to a mono, bicyclic or tricyclic carbocyclic radical (e.g., cyclopropyl, cyclobutyl, cyclopentyl, cyclohexyl, cycloheptyl, cyclooctyl, cyclononyl, cyclopentenyl, cyclohexenyl, bicyclo[2.2.1]heptanyl, bicyclo[3.2.1]octanyl and bicyclo[5.2.0]nonanyl, etc.); optionally containing 1 or 2 double bonds. Cycloalkyl groups may be unsubstituted or substituted by one or more suitable substituents, preferably 1 to 5 suitable substituents, as defined above.

The term “halo” or “halogen,” as used herein, refers to a fluoro, chloro, bromo or iodo radical.

The term “heteroaryl,” as used herein, refers to a monocyclic, bicyclic, or tricyclic aromatic heterocyclic group containing one or more heteroatoms (e.g., 1 to 3 heteroatoms) selected from O, S and N in the ring(s). Heteroaryl groups include, but are not limited to, pyridyl, pyrazinyl, pyrimidinyl, pyridazinyl, thienyl, furyl, imidazolyl, pyrrolyl, oxazolyl (e.g., 1,3-oxazolyl, 1,2-oxazolyl), thiazolyl (e.g., 1,2-thiazolyl, 1,3-thiazolyl), pyrazolyl, tetrazolyl, triazolyl (e.g., 1,2,3-triazolyl, 1,2,4-triazolyl), oxadiazolyl (e.g., 1,2,3-oxadiazolyl), thiadiazolyl (e.g., 1,3,4-thiadiazolyl), quinolyl, isoquinolyl, benzothienyl, benzofuryl, and indolyl. Heteroaryl groups may be unsubstituted or substituted by one or more suitable substituents, preferably 1 to 5 suitable substituents, as defined above.

The term “heterocycle” or “heterocyclyl,” as used herein, refers to a monocyclic, bicyclic, or tricyclic group containing 1 to 4 heteroatoms selected from N, O, S(O)n, P(O)n, PRz, NH or NRz, wherein Rz is a suitable substituent. Heterocyclic groups optionally contain 1 or 2 double bonds. Heterocyclic groups include, but are not limited to, azetidinyl, tetrahydrofuranyl, imidazolidinyl, pyrrolidinyl, piperidinyl, piperazinyl, oxazolidinyl, thiazolidinyl, pyrazolidinyl, thiomorpholinyl, tetrahydrothiazinyl, tetrahydro-thiadiazinyl, morpholinyl, oxetanyl, tetrahydrodiazinyl, oxazinyl, oxathiazinyl, indolinyl, isoindolinyl, quinuclidinyl, chromanyl, isochromanyl, and benzoxazinyl. Examples of monocyclic saturated or partially saturated ring systems are tetrahydrofuran-2-yl, tetrahydrofuran-3-yl, imidazolidin-1-yl, imidazolidin-2-yl, imidazolidin-4-yl, pyrrolidin-1-yl, pyrrolidin-2-yl, pyrrolidin-3-yl, piperidin-1-yl, piperidin-2-yl, piperidin-3-yl, piperazin-1-yl, piperazin-2-yl, piperazin-3-yl, 1,3-oxazolidin-3-yl, isothiazolidine, 1,3-thiazolidin-3-yl, 1,2-pyrazolidin-2-yl, 1,3-pyrazolidin-1-yl, thiomorpholin-yl, 1,2-tetrahydrothiazin-2-yl, 1,3-tetrahydrothiazin-3-yl, tetrahydrothiadiazin-yl, morpholin-yl, 1,2-tetrahydrodiazin-2-yl, 1,3-tetrahydrodiazin-1-yl, 1,4-oxazin-2-yl, and 1,2,5-oxathiazin-4-yl. Heterocyclic groups may be unsubstituted or substituted by one or more suitable substituents, preferably 1 to 3 suitable substituents, as defined above.

The term “hydroxy,” as used herein, refers to an —OH group.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Having described the invention in detail, it will be apparent that modifications and variations are possible without departing from the scope of the invention defined in the appended claims.

### Examples

The following non-limiting examples are provided to further illustrate the present invention.

A known mass of an oil field deposit was completely dissolved in the deposit-inhibiting composition. A precipitant was then added and the rate of asphaltene destabilization was measured under accelerated gravity in a stability analyzer, for example a LUMiFuge analytical centrifuge. The LUMiFuge allows measurement of direct accelerated stability testing. Products that maintained stability during the test time were deemed to be good candidates for further crude oil tests. This method allowed determination of the efficacy of chemical formulations that combine high performance asphaltene stabilizers that have a very poor reaction to subsea injection conditions, with relatively lower molecular weight actives that significantly boost product integrity under high pressure and low temperature conditions and allow use in subsea conditions.

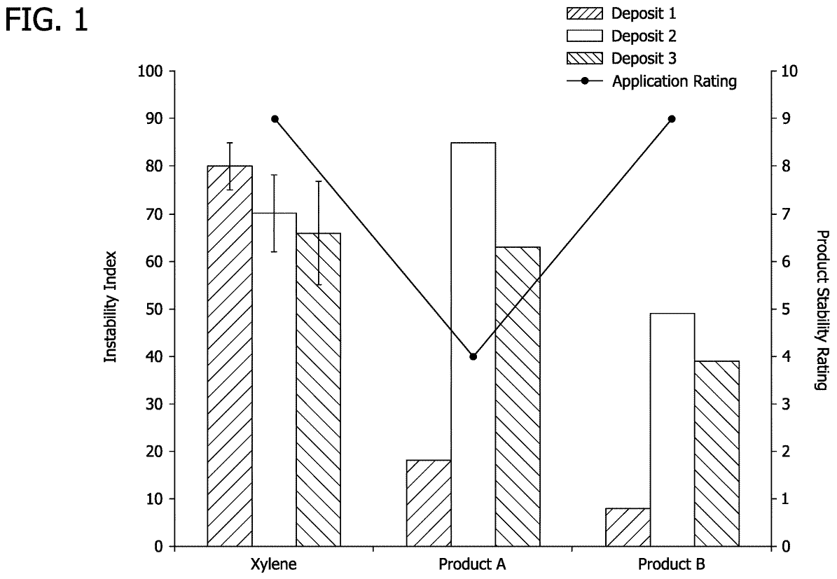

The data in FIG. 1 displays three exemplar oilfield deposits where the new chemical formulation (Product B) exceeded the current best-in-class asphaltene control chemical technology (Product A) in both performance and stability under subsea injection conditions.

Product B comprises 5 wt. % fatty acids, tall-oil, reaction products with N-(2-aminoethyl)-1,2-ethanediamine and 2-propenoic acid, 10 wt. % polyisobutylene succinic anhydride, 6 wt. % of a mixture of mono(2-ethylhexyl)phosphate and di(2-ethylhexyl) phosphate, and 79 wt. % xylene.

The x-axis lists the chemical products examined. Xylene represented the base case when only solvent was used, Product A was the commercially available best-in-class technology, and Product B was the inventive deposition-inhibiting composition.

The primary y-axis that the data bars correspond to the rate at which asphaltenic material precipitated and sedimented under accelerated gravity conditions. The higher the Instability Index, the lower the performance. The secondary y-axis corresponds to the red line data set and represents a measure of product stability under sub-sea application conditions. The higher the number, the lower the risk for application issues, such as gelling and plugging, under these conditions. In each case, the novel formulation in Product B outperformed the current best-in-class technology, Product A. Furthermore, the application, or product stability, rating was considerably higher than that of Product A. This represented a step change in performance and product stability.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description and shown in the accompanying drawings shall be interpreted as illustrative and not in a limiting sense.

1. A deposition-inhibiting composition comprising:
a surface-active component comprising a phosphate ester component, a sulfurized olefin component, or a combination thereof;
a polyalkylene ester; and
an imidazoline compound.

2. The deposition-inhibiting composition of claim 1, further comprising a solvent, wherein the solvent comprises an organic solvent.

3.-4. (canceled)

5. The deposition-inhibiting composition of claim 1, wherein the surface-active component is the phosphate ester component.

6. The deposition-inhibiting composition of claim 1, wherein the surface-active component is a combination of the phosphate ester component and the sulfurized olefin component.

7. (canceled)

8. The deposition-inhibiting composition of claim 1, wherein the phosphate ester component comprises a mixture of a mono(alkyl) phosphate ester and a di(alkyl) phosphate ester, wherein the mono(alkyl) phosphate ester comprises a mono(C₁-C₁₂ alkyl) phosphate ester and the di(alkyl) phosphate ester comprises a di(C₁-C₁₂ alkyl) phosphate ester.

9.-10. (canceled)

11. The deposition-inhibiting composition of claim 8, wherein the mono(alkyl) phosphate ester comprises a mono(C₆-C₁₀ alkyl) phosphate ester and the di(alkyl) phosphate ester comprises a di(C₆-C₁₀ alkyl) phosphate ester.

12.-13. (canceled)

14. The deposition-inhibiting composition of claim 1, wherein the surface-active component is the sulfurized olefin component.

15. (canceled)

16. The deposition-inhibiting composition of claim 14, wherein the sulfurized olefin component comprises sulfurized 1-decene.

17. The deposition-inhibiting composition of claim 1, wherein the polyalkylene ester comprises a polyalkylene succinic ester, a polyalkylene succinic anhydride, polyalkylene succinic acid, or a combination thereof.

18. The deposition-inhibiting composition of claim 17, wherein the polyalkylene ester comprises a polyethylene succinic ester, a polyethylene succinic anhydride, a polypropylene succinic ester, a polypropylene succinic anhydride, a polyisobutylene succinic ester, a polyisobutylene succinic anhydride, polyalkylene succinic acid, or a combination thereof.

19. The deposition-inhibiting composition of claim 17, wherein the polyalkylene ester comprises a polyisobutylene succinic ester.

20. The deposition-inhibiting composition of claim 19, wherein the polyisobutylene succinic ester is derived from a reaction of polyisobutylene succinic anhydride and a polyol, wherein the polyol comprises pentaerythritol, triethanolamine, glycerol, glucose, sucrose, arabitol, erythritol, maltitol, mannitol, ribitol, sorbitol, xylitol, threitol, galactitol, isomalt, iditol, lactitol, or a combination thereof.

21. (canceled)

22. The deposition-inhibiting composition of claim 20, wherein the polyol comprises pentaerythritol.

23. The deposition-inhibiting composition of claim 1, wherein the imidazoline compound has formula (I), 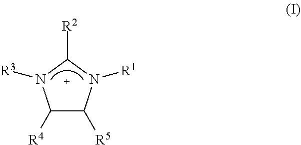
wherein
R¹, R⁴, and R⁵ are each independently selected from hydrogen, alkyl, alkenyl, alkynyl, cycloalkyl, cycloalkenyl, aryl, heteroaryl, and heterocycle,
said alkyl, alkenyl, alkynyl, cycloalkyl, cycloalkenyl, aryl, heteroaryl, and heterocycle each independently, at each occurrence, unsubstituted or substituted with 1 to 3 substituents independently selected from halogen, —COR⁶, —CO₂R⁷, —SO₃R⁸, —PO₃H₂, —CON(R⁹)(R¹⁰), and —N(R¹²)(R¹³);
R² is a radical derived from a fatty acid;
R³ is selected from a radical derived from an unsaturated acid;
R⁶, R⁷, R⁸, R⁹, R¹⁰, and R¹¹ are each independently, at each occurrence, selected from hydrogen, alkyl, and alkenyl;
R¹² and R¹³ are each independently, at each occurrence, selected from hydrogen, alkyl, —CO₂R¹⁵, -alkyl-COR¹⁶, and -alkyl-CO₂R¹⁷; and
R¹⁴, R¹⁵, R¹⁶ and R¹⁷ are each independently, at each occurrence, selected from hydrogen, alkyl, and alkenyl.

24. The deposition-inhibiting composition of claim 23, wherein
R¹ is selected from alkyl, alkenyl, and aryl, each independently substituted with 1 to 3 substituents independently selected from —CO₂R⁷, —CON(R⁹)(R¹⁰), and —N(R¹²)(R¹³);
R⁴ and R⁵ are each independently selected from hydrogen, alkyl, alkenyl, and aryl,
R² is a radical derived from a C₁₀ to C₂₄ fatty acid;
R³ is selected from a radical derived from a C₂ to C₆ unsaturated acid;
R⁷, R⁹, and R¹⁰ are each independently, at each occurrence, selected from hydrogen, alkyl, and alkenyl;
R¹² and R¹³ are each independently, at each occurrence, selected from hydrogen, alkyl, —COR¹¹, and -alkyl-COR¹⁶; and
R¹⁴ and R¹⁶ are each independently, at each occurrence, selected from hydrogen, alkyl, and alkenyl.

25. The deposition-inhibiting composition of claim 23, wherein
(a) R¹ is unsubstituted C₂-C₆-alkyl;
R² is —C₁₇H₃₅, —C₁₇H₃₃, or —C₁₇H₃₁;
R³ is —CH₂CH₂CO₂R^{e}, wherein R^{e} is hydrogen, C₁-C₆-alkyl, or R^{e} is absent;
R⁴ is hydrogen; and
R⁵ is hydrogen; or
(b) R¹ is linear C₂-alkyl, substituted with one substituent that is a terminal —N(R¹²)(R¹³), wherein R¹² is hydrogen and R¹³ is —COR¹⁴, wherein R¹⁴ is —C₁₇H₃₅, —C₁₇H₃₃, or —C₁₇H₃₁;
R² is —C₁₇H₃₅, —C₁₇H₃₃, or —C₁₇H₃₁;
R³ is —CH₂CH₂CO₂R^{e}, wherein R^{e} is hydrogen, C₁-C₆-alkyl, or R^{e} is absent;
R⁴ is hydrogen; and
R⁵ is hydrogen; or
(c) R¹ is linear C₂-alkyl, substituted with one substituent that is a terminal —N(R¹²)(R¹³), wherein R¹² and R¹³ are each a —C₂-alkyl-CO₂R¹⁷, wherein R¹⁷ is hydrogen or R¹⁷ is absent;
R² is —C₁₇H₃₅, —C₁₇H₃₃, or —C₁₇H₃₁;
R³ is —CH₂CH₂CO₂R^{e}, wherein R^{e} is hydrogen, C₁-C₆-alkyl, or R^{e} is absent;
R⁴ is hydrogen; and
R⁵ is hydrogen.

26.-27. (canceled)

28. The deposition-inhibiting composition of claim 1, wherein the imidazoline compound is present at a concentration from about 2 wt. % to about 15 wt. %, the polyalkylene ester is present at a concentration from about 5 wt. % to about 20 wt. %, and the surface-active component is present at a concentration from about 2 wt. % to about 15 wt. %, based on the total weight of the deposition-inhibiting composition.

29. The deposition-inhibiting composition of claim 2, wherein the imidazoline compound is present at a concentration from about 2 wt. % to about 15 wt. %, the polyalkylene ester is present at a concentration from about 5 wt. % to about 20 wt. %, and the surface-active component is present at a concentration from about 2 wt. % to about 15 wt. %, and the solvent is present at a concentration from about 50 wt. % to about 91 wt. % based on the total weight of the deposition-inhibiting composition.

30. (canceled)

31. A method for reducing or preventing deposition of a component of a crude oil comprising contacting the crude oil with the deposition-inhibiting composition of claim 1.

32.-40. (canceled)

41. The method claim 31, wherein the deposition-inhibiting composition of claim 1 is transported through a fluid conduit having a length of at least about 500 feet and the viscosity of the deposition-inhibiting composition is less than 500 centipoise in the fluid conduit.

42.-43. (canceled)
